(19) United States
(12) Patent Application Publication
(10) Pub. No.: US 2026/0180250 A1
(43) Pub. Date: Jun. 25, 2026

(54) CONNECTION STRUCTURE FOR ENERGY STORAGE CONNECTOR

(71) Applicants: SWITCHLAB INC., NEW TAIPEI CITY (TW); SWITCHLAB (SHANGHAI) CO., LTD., SHANGHAI CITY (CN); GAOCHENG ELECTRONICS CO., LTD., SHENZHEN (CN)

(72) Inventors: CHIH YUAN WU, NEW TAIPEI CITY (TW); WEI CHI CHEN, NEW TAIPEI CITY (TW)

(21) Appl. No.: 19/408,601

(22) Filed: Dec. 4, 2025

(30) Foreign Application Priority Data
Dec. 20, 2024 (TW) 113150046

(51) Int. Cl. H01R 13/642; H01R 13/58; H01R 13/629

(52) U.S. Cl. CPC H01R 13/642; H01R 13/5841; H01R 13/629

(57) ABSTRACT

A connection structure for energy storage connector includes a male-end module including connected handle and head portions, the head portion including an outer wall, an inner wall, a connection chamber, and at least three limiting sections provided on the inner wall, and the head portion further including a connection sleeve internally having an electrically conductive section; and a female-end module including a secondary connection sleeve having a secondary outer wall, a secondary inner wall, and a secondary connection chamber internally having a secondary electrically conductive section. When the connection sleeve is plugged into the secondary connection sleeve to form an electrical connection, the secondary outer wall is tangential to the limiting sections at not less than three points of tangency, so that the secondary connection sleeve is retained to the connection chamber, enabling easy, fool-proofing, secured, and 360-degree rotatable assembly of the male-end module to the female-end module.

### FIELD OF THE INVENTION

The present invention relates to a connection structure for energy storage connector, and more particularly to a technique that allows an operator to easily assemble and disassemble a male-end part and a female-end part to ensure secured connection of the two parts without the risk of incorrect connection, while the male-end part is 360-degree rotatable relative to the female-end part.

### BACKGROUND OF THE INVENTION

The use of connecting members to connect two electronic systems or the use of a plug-type connector structure to connect with an energy storage battery system (or a bus system) is a well known skill having been widely applied to electrical devices, terminal devices, and electromechanical equipment. The plug-type connector structure usually includes a plug assembly and a receptacle assembly. When the plug assembly is plugged into the receptacle assembly, an electrical connection is formed between them.

As known by those skilled in the art of electrical connection, the plug assemblies of connectors have very similar external structures and shapes to easily cause mistaken connection, in which a connector plug assembly of an electrical device or a terminal device is plugged into a mismatched receptacle assembly to result in device damage and safety problem in use.

To eliminate the above-mentioned mistaken connection, the prior art connector plug assembly and receptacle assembly employ mutually adapted or matched (round) inner diameter and (round) outer diameter to achieve a fool-proofing (or mistake proofing) effect. Many prior invention patents provide typical embodiments of fool-proofing connector, such as CN 209526244U disclosing “an electrical connector” and CN 217903602U disclosing “a mistake-proofing connector set”.

For instance, in the case a plug assembly and a receptacle assembly have the same polarity (i.e. having a positive polarity or a negative polarity), and a connection sleeve of the plug assembly has a (round) outer diameter generally the same as a (round) inner diameter of a connection chamber of the receptacle assembly, the plug assembly can be plugged into the receptacle assembly to form an electrical connection between them. In other words, when the plug and the receptacle assembly are different in polarity, they would not be successfully connectable through plugging.

In the prior art, when the connection sleeve of the prior art plug assembly has an outer diameter smaller than an inner diameter of the connection chamber of the prior art receptacle assembly, an outer wall structure of the plug assembly and the connection chamber (or side walls) of the receptacle assembly will interfere with each other to avoid mistaken connection of a plug assembly and a receptacle assembly having two different polarities.

There is another important factor for the prior art to use a plug assembly having a round outer diameter to connect with a receptacle assembly having a round inner diameter, that is, the round connection structure of the mutually connected plug assembly and receptacle assembly allows the plug assembly to rotate by 360 degrees relative to the receptacle assembly, so that an operator working in a site environment or in a narrow operating space can conveniently operate the plug assembly for the same to rotate freely relative to the connected receptacle assembly and/or organize the connected cable easily (which can be briefly referred to as cable organization).

Generally, the references cited in the above paragraph [0004] illustrate the applications and structural designs of the conventional (energy storage) connector and related components thereof. If the structure and the manner of application of the conventional connector are redesigned to show a different configuration, the manner of using the connector can be changed to enhance the application effect of the connector, compared to the conventional connector.

For instance, when the structure and the advantage of easy operation are taken into consideration, an improved and more ideal connector structure should be able to resolve the following issues: (1) the improved connector should have a connection manner that allows a male part (or a male-end module) and a female part (or a female-end module) to be securely joined while the operator performs the operation of connecting the male-end part (or the male-end module) and the female-end part (or female-end module), such that the male-end and female-end parts won't become loosened or separated from each other or be wrongly connected to adversely affect the safety of the connector in use; (2) the male-end part is allowed to rotate by 360 degrees after it is connected to the female-end part, so that the operator working in an operating site environment or in a narrow working space can conveniently operate the plug assembly for the same to freely rotate relative to the receptacle assembly and/or can easily organize the connected cable; and (3) the male-end part (or a connection chamber defined by it) has a structure or a shape that allows the operator to easily recognize the (correct) polarity and/or specification of the connector, so as to facilitate the subsequent connection operation.

All these issues have not been taught or disclosed in the above-cited references.

### SUMMARY OF THE INVENTION

A primary object of the present invention is to provide a connection structure for energy storage connector. This connection structure allows easy assembling and disassembling, fool-proofing, and 360-degree rotation to facilitate cable organization. The connection structure for energy storage connector according to the present invention includes a male-end module and a female-end module assembled via the connection structure. The male-end module includes a handle portion and a head portion connected to the handle portion. The head portion includes an outer wall, an inner wall, a connection chamber defined in the inner wall, and at least three limiting sections provided on the inner wall. The limiting sections can be equally and/or non-equally spaced on the inner wall. The head portion (or the connection chamber) includes a connection sleeve and an electrically conductive section provided in the connection sleeve. The female-end module includes a secondary connection sleeve, which has a (round) secondary outer wall and a (round) secondary inner wall, a secondary connection chamber defined in the secondary inner wall, and a secondary electrically conductive section provided in the secondary connection chamber. When the connection sleeve is plugged into the secondary connection sleeve to form an electrical connection between them, the secondary outer wall of the female-end module is tangential to the limiting sections of the male-end module at not less than three points of tangency. Therefore, the secondary connection sleeve is forced to be retained to or enclosed in the polygonal connection chamber to achieve the effect of secured connection of the male-end and the female-end module.

In an embodiment of the present invention, the limiting sections of the male-end module are respectively a flange structure having a curved profile radially inward projected into the connection sleeve (or an inner side of the head portion). The limiting sections are tangential to the (round) secondary outer wall of the secondary connection sleeve of the female-end module to produce at least three points of tangency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a connection structure for energy storage connector according to the present invention, showing the connection structure consisting of a male-end module and a female-end module;

FIG. 2 is a side sectional view of FIG. 1, showing internal structures of the male-end and the female-end module;

FIG. 3 is a fragmentary, assembled side sectional view of the connection structure of the present invention, showing a connection chamber (or an inner wall) of the male-end module (having six limiting sections formed thereon) is plugged into a secondary connection sleeve of the female-end module;

FIG. 4 is a fragmentary assembled side sectional view of the connection structure according to an operable embodiment of the present invention, showing a connection chamber (or an inner wall) of the male-end module (having four limiting sections formed thereon) is plugged into a secondary connection sleeve of the female-end module;

FIG. 5 is a fragmentary, assembled side sectional view of the connection structure of the present invention, showing a connection chamber (or an inner wall) of the male-end module (having five limiting sections formed thereon) is plugged into a secondary connection sleeve of the female-end module;

FIG. 6 is another fragmentary, assembled side sectional view of the connection structure of the present invention, showing a connection chamber (or an inner wall) of the male-end module (having six limiting sections formed thereon) is plugged into a secondary connection sleeve of the female-end module;

FIG. 7 is a fragmentary assembled side sectional view of the connection structure according to an operable embodiment of the present invention, showing a connection chamber (or an inner wall) of the male-end module (having seven limiting sections formed thereon) is plugged into a secondary connection sleeve of the female-end module;

FIG. 8 is a fragmentary assembled side sectional view of the connection structure according to another embodiment of the present invention, showing a connection chamber (or an inner wall) of the male-end module (having eight limiting sections formed thereon) is plugged into a secondary connection sleeve of the female-end module;

FIG. 9 is a fragmentary assembled side sectional view of the connection structure according to an operable embodiment of the present invention, showing a connection chamber (or an inner wall) of the male-end module (having four limiting sections formed thereon) is plugged into a secondary connection sleeve of the female-end module;

FIG. 10 is a fragmentary assembled side sectional view of the connection structure according to a derived embodiment of the present invention, showing a connection chamber (or an inner wall) of the male-end module (having four limiting sections formed thereon) is plugged into a secondary connection sleeve of the female-end module;

### DETAILED DESCRIPTION OF THE PREFERRED EMBODIMENTS

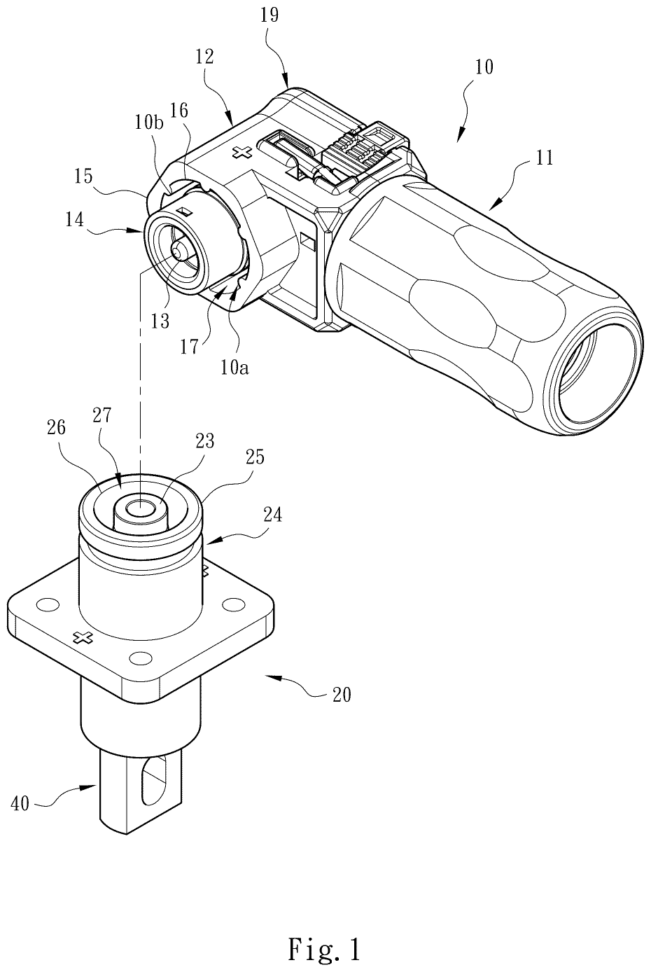

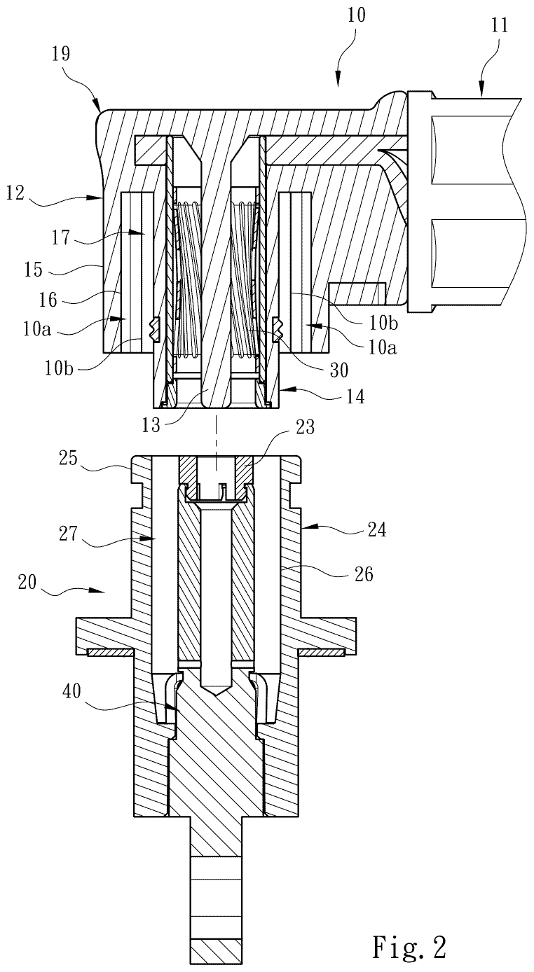

Please refer to FIGS. 1 and 2. A connection structure for energy storage connector according to a preferred embodiment of the present invention is an assembly of a male-end module and a female-end module, which are generally denoted by reference numerals 10 and 20, respectively. The component names of male-end module and female-end module are used to describe the present invention, and it is understood these two component names are exchangeable or changeable. The male-end module 10 includes a handle portion 11, a base zone 19 connected to the handle portion 11, and a head portion 12 connected to the base zone 19 (or the handle portion 11).

In a feasible embodiment, the handle portion 11 and the head portion 12 (and/or the base zone 19) are located on the same one axis line. That is, a straight angle (i.e. a 180-degree angle) is included between the handle portion 11 and the head portion 12. Alternatively, the handle portion 11 and the head portion 12 are located on two axis lines that are perpendicular to each other. That is, a right angle (i.e. a 90-degree bent angle) is included between the head portion 12 and the handle portion 11, as the case shown in the attached drawings.

Further, the handle portion 11 (i.e. a tail end of the connection structure) is connectable to an external conductive wire (not shown), and the head portion 12 is internally provided with a connection sleeve 14 and an electrically conductive section 30 (and/or an insulation bar 13 for preventing an operator's fingers from undesired touching of the electrically conductive section 30) located in the connection sleeve 14. The electrically conductive section 30 is electrically connectable with the above-mentioned external conductive wire. The female-end module 20 includes a secondary connection sleeve 24 and a secondary electrically conductive section 40. The secondary electrically conductive section 40 has end extended into the secondary connection sleeve 24, and this end of the secondary electrically conductive section 40 has an insulation cap 23 fitted thereon to prevent an operator's fingers from undesired touching of the secondary electrically conductive section 40. The male-end module 10 (or the connection sleeve 14) and the female-end module 20 (or the secondary connection sleeve 24) are connectable with each other for the electrically conductive section 30 and the secondary electrically conductive section 40 to be electrically connected. Since this part is a conventional skill, it is not described in detail herein.

The terms used in the following description, including, but not limited to, upper end (section), lower end (section), leftward, rightward, front end (section), rear end (section), sides, outer wall, and inner wall, use the directions shown in the drawings as reference directions. And, the connect structure of energy storage connector means a connection or assembling structure between the male-end module 10 and the female-end module 20.

FIGS. 1, 2, and 3 depict the head portion 12 of the male-end module 10 includes an outer wall 15, an inner wall 16, and a connection chamber 17 defined in the inner wall 16. The above-mentioned connection sleeve 14 is disposed in the connection chamber 17. Alternatively, in another embodiment, the connection sleeve 14 can be outward extended beyond the connection chamber 17.

In the illustrated preferred embodiment, the inner wall 16 has or is provided with at least three limiting sections 10a. The limiting sections 10a are equally spaced and/or non-equally spaced on the inner wall 16. The limiting sections 10a are respectively a flange structure having a curved profile 10b radially projected toward the connection sleeve 14 (or an inner side of the head portion 12). And, the secondary connection sleeve 24 of the female-end module 20 includes a (round) secondary outer wall 25, a (round) secondary inner wall 26, and a (round) secondary connection chamber 27 defined in the secondary inner wall 26. The above-mentioned secondary electrically conductive section 40 has an end extended into the secondary connection chamber 27.

When the connection sleeve 14 is plugged into the secondary connection sleeve 24 and an electrical connection is formed between them, the secondary outer wall 25 of the secondary connection sleeve 24 is in contact with (or is tangential to) the limiting sections 10a on the inner wall 16 to form at least three points of tangency, such that the secondary connection sleeve 24 is retained to or enclosed in the connection chamber 17 to achieve an effect of firmly connection of the male-end module 10 with the female-end module 20 (or the connection sleeve 14 with the secondary connection sleeve 24).

In other words, the at least three limiting sections 10a (or the curved profiles 10b) of the male-end module 10 (or the inner wall 16) are tangential to the (round) secondary outer wall 25 of the secondary connection sleeve 24 of the female-end module 20 at not less than three points of tangency, providing an effect of firmly connecting the male-end module 10 and the female-end module 20 to each other without the risk of becoming loosened, separated, or mismatched to adversely influence the safety in use of the energy storage connector. Further, after the male-end module 10 is connected to the female-end module 20, the tangential connection relationship between the male-end module 10 and the female-end module 20, or between the connection sleeve 14/the connection chamber 17 and the secondary connection sleeve 24, allows the male-end module 10 to rotate by 360 degrees. This feature allows an operator working in a site operating environment or in a narrow operating space to operate the male-end module 10 for the same to be freely rotatably connected to the female-end module 20 and/or to do other works, such as organizing the connected cables.

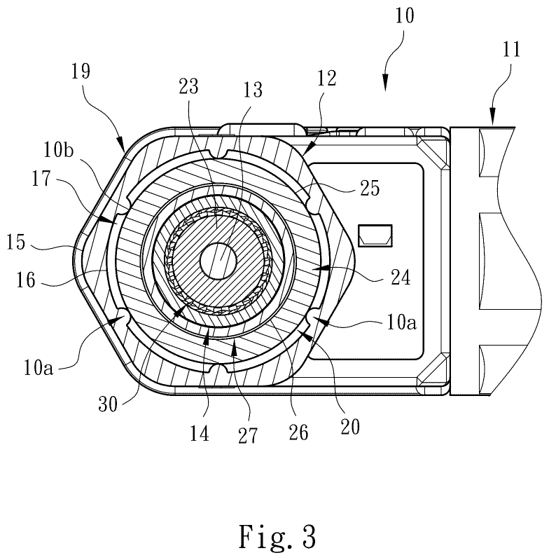

In FIG. 3, the male-end module 10 has six limiting sections 10a being equally spaced (and/or non-equally spaced) on the inner wall 16. The limiting sections 10a are tangential to the secondary outer wall 25 of the secondary connection sleeve 24 at six points of tangency.

In an operable embodiment, for the purpose of matching the polarity and/or the specification set for the energy storage connector, or for the head portion 12 to correspond to the structure of the inner wall 16 (or (the number of) the limiting sections 10a), the outer wall 15 (and/or the base zone 19) can have a polygonal profile. The limiting sections 10a of the inner wall 16 and/or the polygonal outer wall 15 (and/or the base zone 19) are helpful for an operator to easily grip the energy storage connector and recognize whether the male-end module 10 and the female-end module 20 are correctly corresponding to each other in their polarity (and/or specification), so as to facilitate performing of the connection operation. For example, the male-end module 10 (or the outer wall 15 and the limiting sections 10a) may be configured to have different polygonal profiles (or different numbers or structures of limiting sections 10a) to correspond to different positive/negative polarities and/or specifications. Thus, the operator can conveniently determine (or recognize) the polarity and/or the specification of the male-end module 10 and/or the female-end module 20 according to the different polygonal profiles or according to the different numbers and structures of the limiting sections 10a.

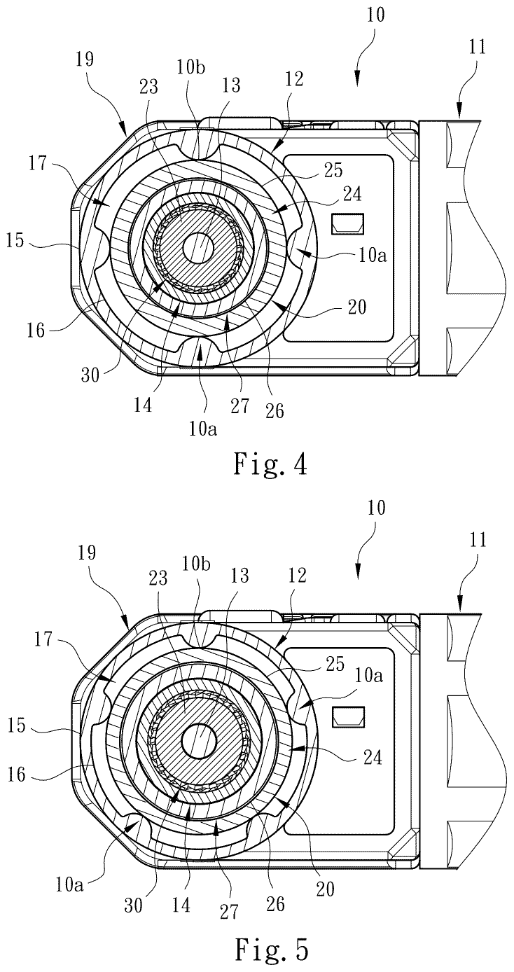

The inner walls 16 shown in FIGS. 4 and 5 respectively have four and five limiting sections 10a, which can be equally spaced (and/or non-equally spaced) on the inner wall 16. The four or the five limiting sections 10a on the inner wall 16 can be tangential to the secondary outer wall 25 of the secondary connection sleeve 24 at four points of tangency and five points of tangency, respectively. And, the outer wall 15 of the male-end module 10 (or the head portion 12) and/or the base zone 19 can have a round profile and/or a polygonal profile.

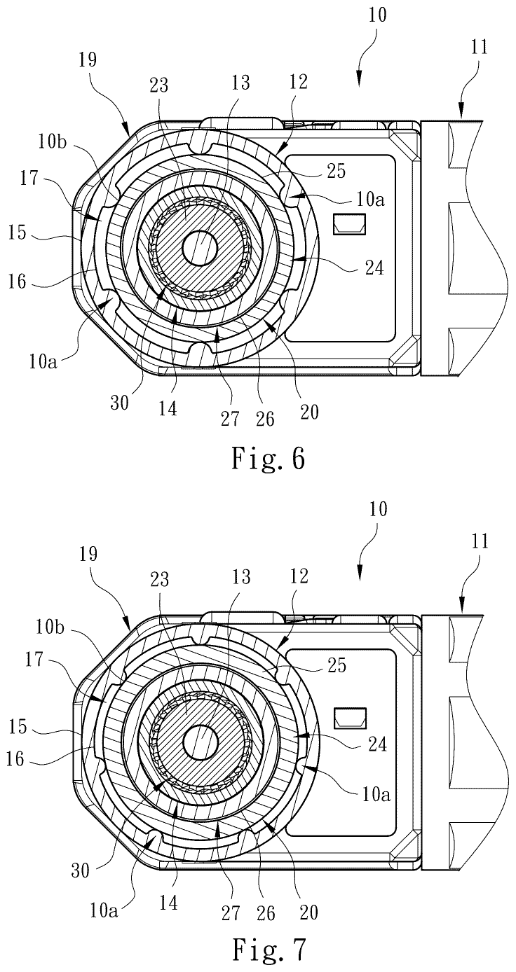

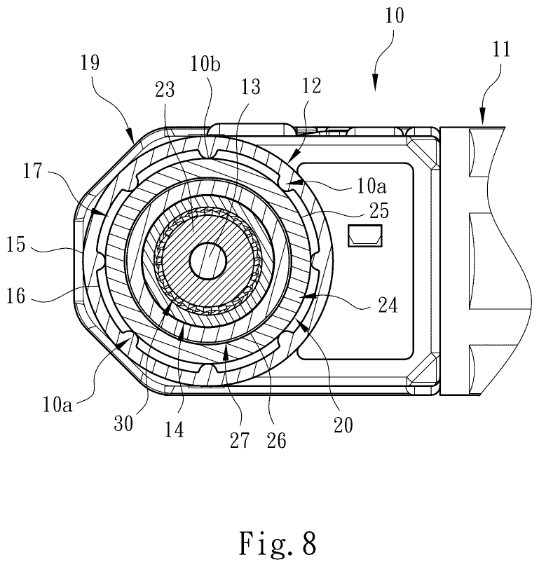

The inner walls 16 shown in FIGS. 6, 7, and 8 respectively have six, seven, and eight limiting sections 10a, which can be equally spaced (and/or non-equally spaced) on the inner wall 16. The six, the seven, and the eight limiting sections 10a are tangential to the secondary outer wall 25 of the secondary connection sleeve 24 at six points of tangency, seven points of tangency, and eight points of tangency, respectively. And, the outer wall 15 of the male-end module 10 (or the head portion 12) and/or the base zone 19 can have a round profile and/or a polygonal profile.

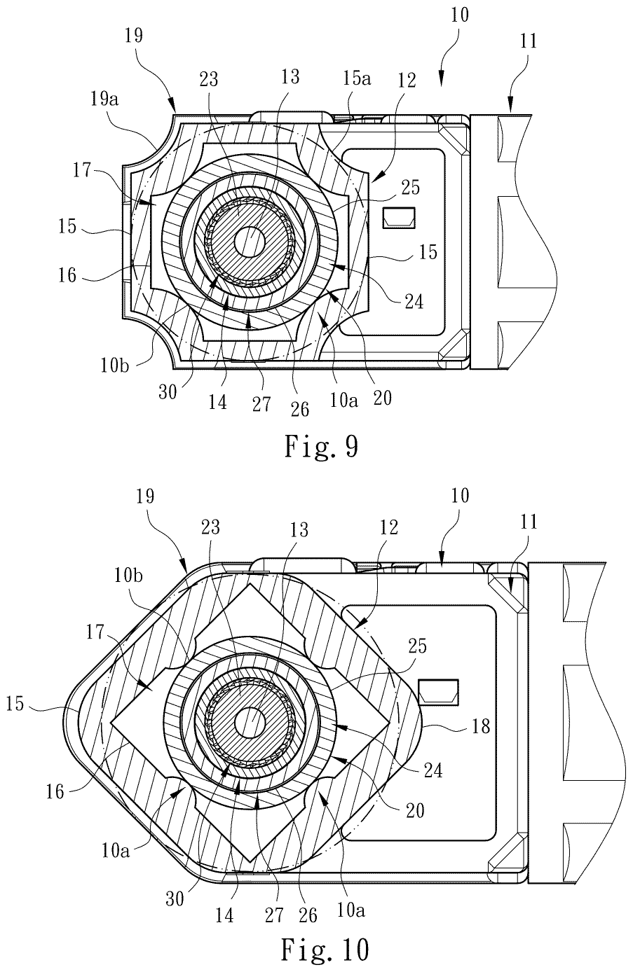

The inner wall 16 of the male-end module 10 shown in FIG. 9 has four equally spaced (and/or non-equally spaced) limiting sections 10a. These limiting sections 10a are tangential to the secondary outer wall 25 of the secondary sleeve 24 at four points of tangency. In this embodiment, the four limiting sections 10a are separately located at four corners (or separately located in four quadrants) of the connection chamber 17; portions of the inner wall 16 located between any two adjacent limiting sections 10a are flat planes. And, the outer wall 15 of the male-end module 10 (or the head portion 12) and/or the base zone 19 can be configured corresponding to the structures of the inner wall 16 and the limiting sections 10a to form a round profile (as indicated by the phantom line in the drawing) and/or a polygonal profile. For example, the outer wall 15 and/or the base zone 19 can respectively include concave sections 15a and concave zones 19a, which are located at some or all corners of the outer wall 15 and/or the base zone 19 (and have profiles/structures corresponding to those of the inner wall 16 and the limiting sections 10a or protrude toward directions the same as those of the limiting section 10a).

The inner wall 16 (or the connection chamber 17) shown in FIG. 10 has a (regular) quadrilateral profile and is provided with four equally spaced (and/or non-equally spaced) limiting sections 10a, which are tangential to the secondary outer wall 25 of the secondary connection sleeve 24 at four points of tangency. And, the outer wall 15 of the male-en module 10 (or the head portion 12) and/or the base zone 19 can have a round profile (as indicated by the phantom line in FIG. 10) and/or a polygonal profile. For example, curved sections 18 can be formed between four connected longer sides and/or at positions where a longer side is connected to another longer side.

It is noted that, if the above-mentioned inner wall 16 (or the connection chamber 17) meets the condition of forming at least three points of tangency, it may form a structure having at least three limiting sections 10a or a structure having twelve limiting sections 10a (for example, having a structure having limiting sections 10a, the number of which can be ranged from 3 to 12).

Generally speaking, compared to the conventional joining structures for (energy storage) connector, the connection structure for energy storage connector according to the present invention meets the requirement of easy to operate and further takes the following factors into consideration and has the following advantages:
(1) The male-end module 10, the female-end module 20, and related joining structure for them all have been redesigned. For instance, the surrounding area of the connection sleeve 14 of the male-end module 10 (or the inner wall 16) forms a connection chamber 17, and the inner wall 16 is provided with at least three limiting sections 10a and curved profiles 10b formed on the limiting sections 10a; and the head portion 12 (and/or the base zone 19 and the outer wall 15) of the male-end module 10 have a round or a polygonal profile. And, the female-end module 20 includes a secondary connection sleeve 24, a secondary connection chamber 27, and a secondary outer wall 25 of the secondary connection sleeve 24, which are corresponding to or are tangential to the limiting sections 10a (or the curved profiles 10b) of the male-end module 10 to form at least three points of tangency. Alternatively, the inner wall 16 and/or the outer wall 15 (or the polygonal connection chamber 17) can be provided with curved sections 18 and/or concaved sections 15a and concave zones 19a. These designs are significantly different from the conventional joining structures for connectors, giving the connection structure for energy storage connector according to the present invention new applications and operation manners different from those of the prior art.
(2) Particularly, in a situation that allows an operator to connect the male-end module 10 to the female-end module 20, the connector with the connection structure of the present invention ensures a firm and secured connection of the male-end module 10 with the female-end module 20 without any risk of forming loosened, separated, or incorrect connection to adversely influence the safety in using the connector. Further, after the male-end module 10 is connected to the female-end module 20, the male-end module 10 is 360-degree rotatable, so that an operator working in a site environment or a narrow operation space can still have the male-end module 10 being freely rotatably connected to the female-end module 20 and/or can conveniently organize the cables connected to the connector. Further, the male-end module 10 can be differently designed in its structure or shape, allowing the operator to easily recognize different polarities (or correct polarity) and/or specifications of the male-end module 10 and to perform correct connection operation.

Therefore, the present invention provides an effective connection structure for energy storage connector that has a spatial configuration different from that of prior art connectors and has incomparable advantages over the prior art connector. Therefore, the present invention is highly improved to fully satisfy the requirements of granting a patent.

It is also understood the present invention has been described with some preferred embodiments that are not intended to limit the scope of the present invention in any way. Many changes and modifications in the described embodiments can be carried out without departing from the scope and the spirit of the invention that is intended to be limited only by the appended claims.

What is claimed is:

1. A connection structure for energy storage connector, comprising a male-end module (10) and a female-end module (20) that are assembled to each other;
the male-end module (10) including a handle portion (11), a base zone (19) connected to the handle portion (11), and a head portion (12) connected to the base zone (19);
the head portion (12) including an outer wall (15), an outer wall (16), and a connection chamber (17) defined in the inner wall (16); the head portion (12) being provided with a connection sleeve (14); the inner wall (16) being provided with at least three limiting sections (10a), and the limiting sections (10a) being provided on the inner wall (16) in a manner selected from the group consisting of being equally spaced and being non-equally spaced;
the female-end module (20) including a secondary connection sleeve (24); the secondary connection sleeve (24) including a round secondary outer wall (25), a secondary inner wall (26), and a secondary connection chamber (27) defined in the secondary inner wall (26); and wherein when the connection sleeve (14) is plugged into the secondary connection sleeve (24), the secondary outer wall (25) of the female-end module (20) is tangential to the limiting sections (10a) at not less than three points of tangency.

2. The connection structure for energy storage connector as claimed in claim 1, wherein the connection sleeve (14) is internally provided with one or both of an electrically conductive section (30) and an insulation bar (13); and the connection sleeve (14) being outward extended beyond the connection chamber (17);
the handle portion (11) and the head portion (12) being located on one of two positions, one of which is on the same axis line, and the other one of which is located on two axis lines that are perpendicular to each other; and
the female-end module (20) including a secondary electrically conductive section (40); the secondary electrically conductive section (40) having an end extended into the secondary connection sleeve (24), and the end of the secondary electrically conductive section (40) extended into the secondary connection sleeve (24) having an insulation cap (23) fitted thereon; and the secondary inner wall (26) of the female-end module (20) having a round profile.

3. The connection structure for energy storage connector as claimed in claim 1, wherein the limiting sections (10a) respectively forms a flange structure having a curved profile (10b) radially inward projected toward an inner side of the head portion (12), and the curved profiles (10b) of the limiting sections (10a) being tangential to the secondary outer wall (25) of the female-end module (20).

4. The connection structure for energy storage connector as claimed in claim 2, wherein the limiting sections (10a) respectively forms a flange structure having a curved profile (10b) radially inward projected toward an inner side of the head portion (12), and the curved profiles (10b) of the limiting sections (10a) being tangential to the secondary outer wall (25) of the female-end module (20).

5. The connection structure for energy storage connector as claimed in claim 1, wherein the limiting sections (10a) are equally spaced on the inner wall (16), and the number of the limiting sections (10a) provided on the inner wall (16) being ranged from three to twelve; and the equally spaced limiting sections (10a) being tangential to the secondary outer wall (25) to form points of tangency, and the number of points of tangency being ranged from three to twelve; and
at least one of the outer wall (15) and the base zone (19) of the male-end module (10) having a profile selected from the group consisting of a round profile and a polygonal profile.

6. The connection structure for energy storage connector as claimed in claim 2, wherein the limiting sections (10a) are equally spaced on the inner wall (16), and the number of the limiting sections (10a) provided on the inner wall (16) being ranged from three to twelve; and the equally spaced limiting sections (10a) being tangential to the secondary outer wall (25) to form points of tangency, and the number of points of tangency being ranged from three to twelve; and
at least one of the outer wall (15) and the base zone (19) of the male-end module (10) having a profile selected from the group consisting of a round profile and a polygonal profile.

7. The connection structure for energy storage connector as claimed in claim 3, wherein the limiting sections (10a) are equally spaced on the inner wall (16), and the number of the limiting sections (10a) provided on the inner wall (16) being ranged from three to twelve; and the equally spaced limiting sections (10a) being tangential to the secondary outer wall (25) to form points of tangency, and the number of points of tangency being ranged from three to twelve; and
at least one of the outer wall (15) and the base zone (19) of the male-end module (10) having a profile selected from the group consisting of a round profile and a polygonal profile.

8. The connection structure for energy storage connector as claimed in claim 4, wherein the limiting sections (10a) are equally spaced on the inner wall (16), and the number of the limiting sections (10a) provided on the inner wall (16) being ranged from three to twelve; and the equally spaced limiting sections (10a) being tangential to the secondary outer wall (25) to form points of tangency, and the number of points of tangency being ranged from three to twelve; and
at least one of the outer wall (15) and the base zone (19) of the male-end module (10) having a profile selected from the group consisting of a round profile and a polygonal profile.

9. The connection structure for energy storage connector as claimed in claim 1, wherein the inner wall (16) is provided with four equally spaced limiting sections (10a), and the four limiting sections (10a) being tangential to the secondary outer wall (25) at four points of tangency;
the four limiting sections (10a) being separately located at four corner positions of the connection chamber (17), and portions of the inner wall (16) located between any two adjacent limiting sections (10a) being flat planes; and
at least one of the outer wall (15) and the base zone (19) of the male-end module (10) having a profile corresponding to that of the inner wall (16) and the limiting sections (10a); and the profile of the outer wall (15) and the base zone (19) being selected from the group consisting of a round profile and a polygonal profile.

10. The connection structure for energy storage connector as claimed in claim 2, wherein the inner wall (16) is provided with four equally spaced limiting sections (10a), and the four limiting sections (10a) being tangential to the secondary outer wall (25) at four points of tangency;
the four limiting sections (10a) being separately located at four corner positions of the connection chamber (17), and portions of the inner wall (16) located between any two adjacent limiting sections (10a) being flat planes; and
at least one of the outer wall (15) and the base zone (19) of the male-end module (10) having a profile corresponding to that of the inner wall (16) and the limiting sections (10a); and the profile of the outer wall (15) and the base zone (19) being selected from the group consisting of a round profile and a polygonal profile.

11. The connection structure for energy storage connector as claimed in claim 3, wherein the inner wall (16) is provided with four equally spaced limiting sections (10a), and the four limiting sections (10a) being tangential to the secondary outer wall (25) at four points of tangency;
the four limiting sections (10a) being separately located at four corner positions of the connection chamber (17), and portions of the inner wall (16) located between any two adjacent limiting sections (10a) being flat planes; and
at least one of the outer wall (15) and the base zone (19) of the male-end module (10) having a profile corresponding to that of the inner wall (16) and the limiting sections (10a); and the profile of the outer wall (15) and the base zone (19) being selected from the group consisting of a round profile and a polygonal profile.

12. The connection structure for energy storage connector as claimed in claim 4, wherein the inner wall (16) is provided with four equally spaced limiting sections (10a), and the four limiting sections (10a) being tangential to the secondary outer wall (25) at four points of tangency;
the four limiting sections (10a) being separately located at four corner positions of the connection chamber (17), and portions of the inner wall (16) located between any two adjacent limiting sections (10a) being flat planes; and
at least one of the outer wall (15) and the base zone (19) of the male-end module (10) having a profile corresponding to that of the inner wall (16) and the limiting sections (10a); and the profile of the outer wall (15) and the base zone (19) being selected from the group consisting of a round profile and a polygonal profile.

13. The connection structure for energy storage connector as claimed in claim 9, wherein at least one of the outer wall (15) and the base zone (19) of the male-end module (10) is provided on at least some corners with at least one of concave sections (15a) and concave zones (19a), respectively; and
at least one of the concave sections (15a) and the concave zones (19a) being projected in directions the same as those of the limiting sections (10a).

14. The connection structure for energy storage connector as claimed in claim 10, wherein at least one of the outer wall (15) and the base zone (19) of the male-end module (10) is provided on at least some corners with at least one of concave sections (15a) and concave zones (19a), respectively; and
at least one of the concave sections (15a) and the concave zones (19a) being projected in directions the same as those of the limiting sections (10a).

15. The connection structure for energy storage connector as claimed in claim 11, wherein at least one of the outer wall (15) and the base zone (19) of the male-end module (10) is provided on at least some corners with at least one of concave sections (15a) and concave zones (19a), respectively; and
at least one of the concave sections (15a) and the concave zones (19a) being projected in directions the same as those of the limiting sections (10a).

16. The connection structure for energy storage connector as claimed in claim 12, wherein at least one of the outer wall (15) and the base zone (19) of the male-end module (10) is provided on at least some corners with at least one of concave sections (15a) and concave zones (19a), respectively; and
at least one of the concave sections (15a) and the concave zones (19a) being projected in directions the same as those of the limiting sections (10a).

17. The connection structure for energy storage connector as claimed in claim 1, wherein the inner wall (16) has a square profile; the inner wall (16) being provided with four equally spaced limiting sections (10a), and the limiting sections (10a) being tangential to the secondary wall (25) at four points of tangency; and
at least one of the outer wall (15) and the base zone (19) of the male-end module (10) having a profile selected from the group consisting of a round profile and a polygonal profile.

18. The connection structure for energy storage connector as claimed in claim 2, wherein the inner wall (16) has a square profile; the inner wall (16) being provided with four equally spaced limiting sections (10a), and the limiting sections (10a) being tangential to the secondary wall (25) at four points of tangency; and
at least one of the outer wall (15) and the base zone (19) of the male-end module (10) having a profile selected from the group consisting of a round profile and a polygonal profile.

19. The connection structure for energy storage connector as claimed in claim 3, wherein the inner wall (16) has a square profile; the inner wall (16) being provided with four equally spaced limiting sections (10a), and the limiting sections (10a) being tangential to the secondary wall (25) at four points of tangency; and
at least one of the outer wall (15) and the base zone (19) of the male-end module (10) having a profile selected from the group consisting of a round profile and a polygonal profile.

20. The connection structure for energy storage connector as claimed in claim 4, wherein the inner wall (16) has a square profile; the inner wall (16) being provided with four equally spaced limiting sections (10a), and the limiting sections (10a) being tangential to the secondary wall (25) at four points of tangency; and
at least one of the outer wall (15) and the base zone (19) of the male-end module (10) having a profile selected from the group consisting of a round profile and a polygonal profile.

21. The connection structure for energy storage connector as claimed in claim 17, wherein at least one of the outer wall (15) and the base zone (19) has a quadrilateral profile, and a curved section (18) being formed between two longer sides that are connected to each other.

22. The connection structure for energy storage connector as claimed in claim 18, wherein at least one of the outer wall (15) and the base zone (19) has a quadrilateral profile, and a curved section (18) being formed between two longer sides that are connected to each other.

23. The connection structure for energy storage connector as claimed in claim 19, wherein at least one of the outer wall (15) and the base zone (19) has a quadrilateral profile, and a curved section (18) being formed between two longer sides that are connected to each other.

24. The connection structure for energy storage connector as claimed in claim 20, wherein at least one of the outer wall (15) and the base zone (19) has a quadrilateral profile, and a curved section (18) being formed between two longer sides that are connected to each other.
